(19) United States
(12) Patent Application Publication
(10) Pub. No.: US 2006/0264133 A1
(43) Pub. Date: Nov. 23, 2006

(54) Coated Aerogel Composites

(75) Inventors: Mark Thaddeus Krajewski, West Newton, MA (US); Poongunran Muthukumaran, Worcester, MA (US); Christopher Michael Comeaux, Worcester, MA (US); Jon Nebo, Waltham, MA (US)

Correspondence Address: ASPEN AEROGELS INC.;IP DEPARTMENT, 30 FORBES ROAD, BLDG. B, NORTHBOROUGH, MA, 01532, US

(73) Assignee: ASPEN AEROGELS,INC., Northborough, MA (US)

(21) Appl. No.: 11/460,915

(22) Filed: Jul. 28, 2006

Related U.S. Application Data
(63) Continuation-in-part of application No. 11/279,987, filed on Apr. 17, 2006.
(60) Provisional application No. 60/704,133, filed on Jul. 29, 2005.
(60) Provisional application No. 60/594,541, filed on Apr. 15, 2005.

(51) Int. Cl. B32B 5/02; B32B 27/04

(52) U.S. Cl. 442/104; 442/99

(57) ABSTRACT

Many types of aerogel materials may be coated with polyorganosiloxane based coating compositions. Several such compositions, coating methods and additional ingredients are described. Such coatings add strength and increase the ability to use such aerogel materials in rugged environments. Various compositions include polyorganosiloxane components, crosslinkers, catalysts, optional fillers and other compounds.

### CROSS-REFERENCES TO RELATED APPLICATIONS

This application claims benefit of priority to U.S. Provisional Patent Application Ser. No. 60/704,133 filed on Jul. 29, 2005 and Ser. No. 60/594,541 filed on Apr. 15, 2005; this application is a continuation-in-part of U.S. patent application Ser. No. 11/279,987 filed on Apr. 17, 2006 the contents of all of the above are hereby incorporated by reference as if fully set forth.

### FIELD OF INVENTION

The present invention relates to methods and compositions for coating an aerogel material and preferably an aerogel composite with a polyorganosiloxane based material.

### SUMMARY OF THE INVENTION

Composite articles including a substantially planar aerogel material comprising at least one surface; and at least a layer of a composition comprising a polyorganosiloxane and a cross linker on at least one surface of said aerogel material are disclosed. The composite may further comprise a fibrous material and may be in the form of chopped fiber, fibrous batting, lofty fibrous batting or woven form.

The aerogel material in the composites may be substantially continuous through said fibers. The composite may further comprise a catalyst for reaction between said polyorganosiloxane and said crosslinker.

The fibrous material of the composites may comprise or maybe made of polyester, carbon, polyacrylonitrile, oxidized polyacrylonitrile, silica, quartz, fiberglass, polyamide, polyethylene, polypropylene, cotton, polyimide, polytetrafluoroethylene(PTFE), polybenzimidazole, polyphenylenebenzo-bisoxasole, polyetherether ketone, polyacrylate, polyaramids, poly-metaphenylene diamine, poly-paraphenylene terephthalamide, ultra high molecular weight polyethylene, novoloid resins, polyacrylonitrile(Pan), oxidized PAN, carbon or combinations thereof.

The coated polyorganosiloxane layer may exhibit a tear strength of 30 kN/m, preferably between 35 and 60 kN/m.

The coating layer thickness may be between about 1 mil and about 10 mil.

The polyoganosiloxane used in the composite maybe elastomer-forming or elastomeric in nature. The polyoganosiloxane layers may exhibit an elongation-at-break of at least 400%, preferably, between 600 and 1000%.

The polyorganosiloxane composition of different embodiments may be made from elastomer-forming composition comprising:

100 parts by weight of a polyorganosiloxane material having on average two silicon-bonded alkenyl groups per molecule;

(b) an organosilicon compound having at least three silicon-bonded hydrogen atoms per molecule, in an amount which is sufficient to give a molar ratio of Si—H groups in (b) to alkenyl groups in (a) of from 1.1/1 to 5/1;

(c) from 1 to 25 parts by weight of a chain extender, comprising an polyorganosiloxane having two silicon-bonded hydrogen atoms;

(d) a group VIII metal based catalyst component in sufficient amounts to catalyse the addition reaction between (a) on the one hand and (b) and (c) on the other; and

(e) from 5 to 40 parts by weight of a hydrophobic filler.

The polyoganosiloxane used in the composite maybe made from elastomer-forming composition comprising:

(a) 100 parts by weight of a polyorganosiloxane material having on average two silicon-bonded alkenyl groups per molecule, preferably one linked to each of the terminal silicon atoms of the molecule;

(b) an organosilicon compound having at least three silicon-bonded hydrogen atoms per molecule, in an amount which is sufficient to give a molar ratio of Si—H groups in (b) to alkenyl groups in (a) of from 1.1/1 to 5/1;

(c) 1 to 25 parts by weight of a polyorganosiloxane material having a silicon-bonded alkenyl groups linked to each of the terminal silicon atoms of the molecule and in addition at least one alkenyl group linked to a non-terminal silicon atom in the polyorganosiloxane chain;

(d) a group VIII metal based catalyst component in sufficient amounts to catalyze the addition reaction between (a) on the one hand and (b) and (c) on the other; and

(e) from 5 to 40 parts by weight of a hydrophobic filler.

The aerogel material in the composites may have opacifiers, IR reflectors, UV reflectors, B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof. The composites of different embodiments may also have a binder

The polyorganosiloxane composition useful in coating aerogels may comprise:

an organopolysiloxane polymer having a siloxane backbone of degree of polymerization no more than 150 end-blocked with at least two silicon-bonded groups R, wherein R denotes an olefinically unsaturated hydrocarbon substituent, an alkoxy group or a hydroxy group;

(B) a cross-linking organosilicon material having at least 3 silicon-bonded reactive groups;

(C) a catalyst capable of promoting the reaction between the silicon-bonded groups R of compound A and the silicon-bonded reactive group of compound B;

(D) optionally a non-reinforcing filler; and

(E) optionally up to a maximum of 3% by weight of a reinforcing filler; wherein organopolysiloxane (A) is a polymer containing vinylmethylsiloxane units in which 10 to 50 mole % of the siloxane units are vinylmethylsiloxane units or a polysiloxane containing both silicon-bonded vinyl group and silicon-bonded hydroxyl group.

Compound B has the general formulae (VII) or (IX):

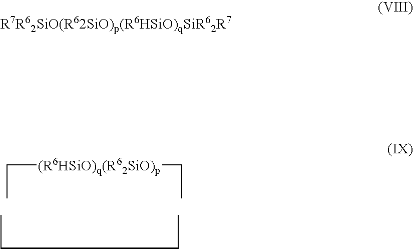

wherein R⁶ denotes an alkyl or aryl group having up to 10 carbon atoms, R⁷ is a group R⁶ or a hydrogen atom, p has a value of from 0 to 20, q has a value of from 1 to 70, and there are at least 3 silicon-bonded hydrogen atoms present per molecule.

The coat weight of different coatings described herein may be from about 1 to about 200 g/m², preferably from about 10 to about 100 g/m², most preferably from about 15 g/m² to about 75 g/m². Such coating smay further be cured either by allowing sufficient time or by the use of a catalyst or other external energy sources like heat, UV, microwave or the like. The fillers may be laminar fillers having a Mohs value of less than 5.

The c polyorganosiloxane composition useful for coating aerogels as described herein may comprise:

a polyorganosiloxane having at least 2 silicon-bonded alkenyl groups per molecule,

(B) a polyorganohydrogensiloxane containing at least 2 silicon-bonded hydrogen groups,

(C) a platinum group metal catalyst capable of promoting the reaction between the silicon-bonded alkenyl of component A and the silicon-bonded reactive group of component B,

(D) a reinforcing filler,

(E) 0.1 to 5 percent by weight, based on the total weight of components A through E, of a compound selected from the group consisting of natural drying oils and modified natural drying oils, liquid diene compounds, and unsaturated fatty acid esters.

Such coating weights on the aerogel materials may range from about 1 to about 200 g/m², preferably from about 10 to about 100 g/m², most preferably from about 15 g/m² to about 75 g/m².

The polyorganosiloxane coating composition useful for coating aerogel materials may comprise 100 parts by weight of an organopolysiloxane having at least 2-silicongroups selected from hydroxyl or alkoxy groups in each molecule;

0.5 to 100 parts by weight of a microparticulate silica;

0.01 to 10 parts by weight of a curing catalyst; and

0.01 to 10 parts by weight of a silatrane derivative.

### DETAILED DESCRIPTION

The present invention provides methods and devices to coat aerogel materials and specifically flexible aerogels with a variety of coating compositions. Aerogels are a unique class of materials with low density, low thermal conductivity, high surface area, open pore structure and nanostructure. Aerogels applicable to the present invention include such aerogels which are reinforced by a fibrous structure. Such reinforcements provide strength and flexibility to the aerogel structure. U.S. Pat. Nos. 6,068,882, 6,087,407, 6,770,584, 5,124,101, 5,973,015, 6,479,416, 5,789,075, 5,866,027, 5,786,059, 5,972,254, 4,636,738, 4,447,345, PCT application WO9627726, U.S. patent applications 20020094426, 2003077438, Japanese patent JP8034678, U.K. Patent GB1205572 teach some of the aerogel materials that may be practiced with the embodiments of the present invention. These documents are incorporated herein by reference to teach the methods of manufacturing such flexible aerogel materials, at least in part. Flexible aerogel materials can also have form factors that are blankets or thin strips. Although many of the embodiments of the present invention are focused towards coating aerogel composites, they can also be used to coat other forms of aerogels.

Fiber reinforcement when applied appropriately results in flexible aerogel materials. Such flexibility in aerogel materials is desirable in a variety of applications where said aerogel materials can be drop-in-replacements for the existing materials.

However, flexibility sometimes may also result in certain damage to the aerogel structure. Though it may not affect other critical properties of aerogel materials, it can present a nuisance to physical handling. The present invention, in many of its embodiments provides methods to minimize the effects of such damage and further prevent any such damaged material from dislodging from the material matrix. Hence, any consequential mechanical handling issues related to aerogel particulate materials on the surface of such aerogel material are avoided and substantially reduced by the methods of the present invention.

Present invention provides various siloxane or silicon based compositions for coating onto aerogel materials and methods of coating the same. The polyorganosiloxane compositions of several embodiments can further be understood in the context of U.S. Pat. Nos. 5,708,057, 6,037,279, 6,354,620, 6,268,300 or 6,180,712 which are incorporated by reference here.

The curable silicon-based coating composition can be coated onto an aerogel material and cured in situ. Because the coating composition is curable to a flexible coating at a coat weight up to 15 g/m² and in some embodiments up to 300 g/m², it is suitable for coating flexible aerogel blankets. Flexibility means that the coated aerogel can be folded easily, as is for example required by insulation in a Pipe-in-Pipe application in Oil & Gas industry. Though flexible aerogels are preferred to be coated with several compositions described herein, any aerogel including rigid ones may also be coated with such compositions.

Curable polyorganosiloxane compositions of different embodiments of the present invention are clearly distinguishable from compositions with only linear polymeric polyorganosiloxanes such as silicone oils in that such silicone oils do not contain any active cross linking groups for active or passive curing before, during or after the composition is applied to the intended surface. Aerogel materials useful in embodiments are typically materials that can exist on their own unlike dielectric films which are so thin that they need a substrate to stand on.

Useful organopolysiloxane polymers (A) for use in the curable silicon-based compositions according to the embodiments have units of the general formula R¹ₐR²_{b}SiO_{4-a-b/2} (I), wherein R¹ is a monovalent hydrocarbon group having up to 18 carbon atoms, R² is a monovalent hydrocarbon or hydrocarbonoxy group or a hydroxyl group, a and b have a value of from 0 to 3, the sum of a+b being no more than 3.

Preferably the organopolysiloxane polymers have a generally linear nature having the general structure II below

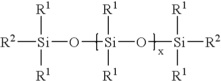

wherein R¹ and R² have the same meaning as above, and wherein x is an integer of no more than 148, preferably having a value of from 5 to 100, more preferably 8 to 50. It is particularly preferred that R¹ denotes an alkyl or aryl group having from 1 to 8 carbon atoms, e.g. methyl, ethyl, propyl, isobutyl, hexyl, phenyl or octyl. More preferably at least 25% of all R¹ groups are methyl groups, most preferably substantially all R¹ groups are methyl groups. R² is preferably selected from a hydroxyl group, an alkoxy group or an aliphatically unsaturated hydrocarbon group. More preferably R² denotes either a hydroxyl group or alkoxy group having up to 3 carbon atoms suitable for condensation reactions, or an alkenyl or alkynyl group having up to 6 carbon atoms, more preferably vinyl, allyl or hexenyl, suitable for addition reactions.

Preferably the organopolysiloxane polymers (A) have at least two silicon-bonded alkenyl groups per molecule. Preferred materials have a viscosity of not greater than 500 mPa·s at 25° C., more preferably a viscosity of from 4 to 100 mPa·s at 25° C., although these can be mixed with organopolysiloxanes (A) of higher viscosity, especially if the more viscous organopolysiloxanes have high functionality. Although these alkenyl-substituted polymers (A) are preferably as described above under structure (II), they may be homopolymers, copolymers or mixtures thereof which comprise units of the general formula R¹ₐR³_{b}SiO_{4-a-b/2} wherein R¹ and a are as described above, R³ is an alkenyl group having up to 8 carbon atoms and c is 0 or 1 provided that a+c is not greater than 3. In yet another embodiment, preferred viscosities are in the range of 1-100 Pa-s.

The organopolysiloxane (A) can for example comprise at least one polymer containing vinylmethylsiloxane units, which can for example comprise from 0.5% or 1% by weight of the diorganosiloxane units of (A) up to 50 or even 100%. Mixtures of such vinylmethylsiloxane polymers can be used; for example either a polydiorganosiloxane (A) in which 10 to 50 mole % of the siloxane units are vinylmethylsiloxane units or a polydiorganosiloxane (A) in which 1 to 10 mole % of the siloxane units are vinylmethylsiloxane units or a mixture of both can be used as polydiorganosiloxane (A). The polydiorganosiloxane (A) preferably contains vinyldimethylsiloxy terminal groups, although a vinylmethylsiloxane polymer can contain other terminal groups such as trimethylsilyl.

Alternatively organopolysiloxane (A) can be a polydiorganosiloxane having the general formula (III), below

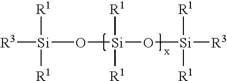

wherein R¹ is a defined above, R³ denotes an alkenyl group having up to 8 carbon atoms, with the formula —R⁴_{y}—CH═CH₂, where R⁴ denotes a divalent hydrocarbon group having up to 6 carbon atoms, preferably an alkylene group having up to 4 carbon atoms, y has a value of 0 or 1, and x has a value of from 5 to 100, preferably 8 to 50, most preferably 8 to 20. Such an .alpha . . . omega.-vinyldimethylsiloxy polydimethylsiloxane polymer preferably has a viscosity of from 4 to 100 mPa·s at 25° C., more preferably 4 to 50 mPa·s, and can be used as the only organopolysiloxane (A) or as a mixture with a vinylmethylsiloxane polymer.

The organopolysiloxane (A) can advantageously comprise a polysiloxane containing both silicon-bonded vinyl groups and silicon-bonded hydroxy groups, for example a hydroxy-terminated poly(dimethyl, vinylmethyl siloxane).

In an embodiment, the polyorganosiloxane (A) used in the present composition is a liquid and contains at least 2 alkenyl groups in each molecule. This alkenyl is exemplified by vinyl, allyl, methacryl, and hexenyl. The non-alkenyl Si-bonded organic groups present in (A) can be exemplified by alkyl groups such as methyl, ethyl, propyl, butyl, pentyl, isopropyl, isobutyl, cyclopentyl, and cyclohexyl; aryl groups such as phenyl and naphthyl; aralkyl groups such as benzyl and 1-phenylethyl; halogenated alkyl groups such as chloromethyl, 3-chloropropyl, 3,3,3-trifluoropropyl, and nonafluorobutylethyl; halogenated aryl groups such as 4-chlorophenyl, 3,5-dichlorophenyl, and 3,5-difluorophenyl; and aryl groups substituted by halogenated alkyl, such as 4-chloromethylphenyl and 4-trifluoromethylphenyl. The molecular structure of this polyorganosiloxane (A) will generally be a straight chain, but may include partial chain branching. The alkenyl may be bonded in terminal or pendant position on the polyorganosiloxane. While the viscosity of polyorganosiloxane (A) at 25.° degree. C. is such that it is a pumpable liquid and can spread out on the fabric without solvent. The viscosity preferably is in the range from 100 to 100,000 mPa·s based on considerations. More preferably, the viscosity of component (A) at 25° C. is in the range of 1000 to 50,000 mPa·s.

The polyorganosiloxane (A) is exemplified by dimethylvinylsiloxy-endblocked polydimethylsiloxane, dimethylvinylsiloxy-endblocked dimethylsiloxane-methylphenylsiloxane copolymers, dimethylvinylsiloxy-endblocked dimethylsiloxane-3,3,3-trifluoropropylmethylsiloxane copolymers, dimethylvinylsiloxy-endblocked dimethylsiloxane-methylvinylsiloxane copolymers, trimethylsiloxy-endblocked dimethylsiloxane-methylvinylsiloxane copolymers, and trimethylsiloxy-endblocked dimethylsiloxane-hexenylmethylsiloxane copolymers.

The cross-linking organosilicon material (B) is an organosilicon compound, which is capable of reacting with component (A) above. Suitable organosilicon compounds may vary from viscous materials to freely flowing liquids. Preferred materials have a viscosity of not greater than 100 mPa·s at 25° C., more preferably 2 to 55 mPa·s at 25° C. They may be monomers, homopolymers, copolymers or mixtures thereof which comprise at least one unit of the general formula R¹ₐR⁵_{b}SiO_{4-a-b/2} wherein R¹, a and b are as described above, R⁵ is a hydrogen atom, a hydroxyl or an alkoxy group, except that where the organosilicon compound is a monomer (a silane) a+b would be 4 and b would be at least 3.

Cross-linking organosilicon materials (B) are preferably selected from silanes, low molecular weight organosilicon resins and short chain organosiloxane polymers. The cross-linking material (B) has at least 3 silicon-bonded substituents R⁵ that are capable of reacting with the silicon-bonded group R² of the organopolysiloxane polymer (A) described above. Where the group R² is a hydroxyl or alkoxy group, it is preferred that the reactive substituents on the cross-linking organosilicon compound are either alkoxy groups or hydroxyl groups, allowing the condensation to take place between the two components according to the general reaction scheme (IV) or (V), wherein R* denotes an alkyl group
≡Si—OH+HO—Si.≡→≡Si—O—Si≡+H₂O (IV)
≡Si—OR*+HO—Si≡→≡Si—O—Si≡+R*—OH (V)

Where the group R² of organopolysiloxane (A) is hydroxyl or an aliphatically unsaturated hydrocarbon group, the reactive substituents R⁵ on the cross-linking organosilicon material are hydrogen atoms, allowing either condensation or addition reaction between the cross-linking organosilicon material and the organopolysiloxane polymer (A), according to the general reaction scheme (VI) or (VII), wherein R⁴ is a divalent hydrocarbon group as defined above and y is 0 or 1.
≡Si—R⁴_{y}CH═CH₂+H—Si≡→ . . . ≡.Si—R⁴_{y}CH₂—CH₂—Si≡ (VI)
≡Si—OH+H—Si≡→≡Si—O—Si≡+H₂ (VII)

Suitable silanes that may serve as cross-linking organosilicon compounds include alkyltrialkoxy silane, e.g. methyltrimethoxy silane, ethyltrimethoxy silane, methyltriethoxy silane or methyltrihydrosilane. Suitable organosilicon resin compounds include organosilicon resins consisting mainly of tetrafunctional siloxane units of the formula SiO_{4/2} and monofunctional units RₐR⁵_{b}SiO_{1/2}, wherein R, R⁵, a and b are as defined above. Suitable short chain organosiloxane polymers include short chain polyorganosiloxanes having at least 3 silicon-bonded alkoxy, hydroxyl or hydrogen atoms per molecule, e.g. trimethyl siloxane endblocked polymethylhydrosiloxane having up to 20 carbon atoms, tetramethylcyclotetrasiloxane and silanol end-blocked dimethylsiloxane-methylsilanol copolymers. Alternatively, other organic crosslinking agents such as diiocynates can be used.

Organosilicon component (B) is preferably a short chain polyorganosiloxane having at least 3 silicon-bonded hydrogen atoms, preferably having a silicon-bonded hydrogen atom on at least 40% of, more preferably on the majority of silicon atoms in the molecule. Particularly preferred are organosilicon compounds that are substantially linear or cyclic compounds. However, small amounts of trifunctional or tetrafunctional siloxane units may also be present.

Preferred compounds for (B) are organosilicon compounds having the general formulae (VIII) or (IX)

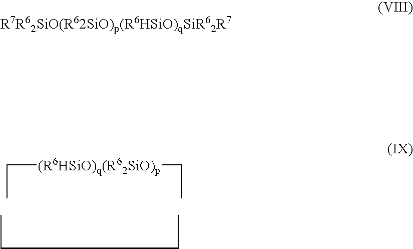

wherein R⁶ denotes an alkyl or aryl group having up to 10 carbon atoms, R⁷ is a group R⁶ or a hydrogen atom, p has a value of from 0 to 20, q has a value of from 1 to 70, and there are at least 3 silicon-bonded hydrogen atoms present per molecule. It is not important if the silicon-bonded hydrogen atoms are on terminal silicon atoms for linear siloxane compounds (VII) or not. It is preferred that R⁶ denotes a lower alkyl group having no more than 3 carbon atoms, most preferably a methyl group. R⁷ preferably denotes an R⁶ group, provided at least 3 of them are hydrogen atoms. Most preferably p and q have similar values or p=0 and q has a value of from 6 to 70, more preferably 20 to 60, or where cyclic organosilicon materials are used, from 3 to 8. The cross-linking component may comprise a mixture of several organosilicon compounds as described.

In the embodiment with component (A) having at least two alkenyl groups, the component (B) may be a polyorganohydrogensiloxane which acts as a cross-linking agent in the composition of the present invention. Specifically, in the presence of the platinum type catalyst of component (C), the hydrogen atoms bonded to silicon atoms in component (B) undergo an addition reaction with the alkenyl groups bonded to silicon atoms in component (A); as a result, the composition of the present invention is cross-linked and cured. It is necessary that the polyorganosiloxane of component (B) have at least two hydrogen atoms bonded to silicon atoms in each molecule. It will be recognized, however, by those skilled in the art that if there are only two alkenyl groups on component (A), there must be more than two silicon-bonded hydrogen groups on component (B) to get a crosslinked rubber. Organic groups other than these hydrogen atoms bonded to silicon atoms which may be present in this component include alkyl groups such as methyl groups, ethyl groups or propyl groups; aryl groups such as phenyl groups or tolyl groups; and substituted alkyl groups such as 3,3,3-trifluoropropylgroups or 3-chloropropyl groups.

The molecular structure of component (B) may be linear, linear including branching, cyclic or network-form. There are no particular restrictions on the molecular weight of component (B); however, it is desirable that the viscosity at 25.degree. C. be 3 to 10,000 mPa·s. Furthermore, the amount of component (B) that is added to the composition is an amount which is such that the ratio of the number of moles of hydrogen atoms bonded to silicon atoms in the present composition to the number of moles of alkenyl groups bonded to silicon atoms is in the range of 0.5:1 to 15:1, and preferably in the range of 1:1 to 10:1. If this molar ratio is less than 0.5, curing of the present composition becomes insufficient, while if this molar ratio exceeds 15:1, excess hydrogen gas is evolved so that foaming occurs.

Component (B) is exemplified by the following: trimethylsiloxy-endblocked polymethydrogensiloxanes, trimethylsiloxane-endblocked dimethylsiloxane-methylhydrogensiloxane copolymers, dimethylphenylsiloxy-endblocked methylphenylsiloxane-methylhydrogensiloxane copolymers, cyclic polymethylhydrogensiloxane, and copolymers composed of dimethylhydrogensiloxy and SiO_{4/2} units.

The catalyst (C) may be any compound which catalyses the reaction between components (A) and (B) above. Where the reaction is a condensation reaction, the catalyst may be any of the known condensation catalysts, e.g. acids, including sulphuric acid, hydrochloric acid, Lewis acids, bases, e.g. sodium hydroxide, potassium hydroxide, tetramethylammonium hydroxide, tetrabutylphosphonium silanolate and amines, catalysts based on tin or titanium, e.g. dialkyltin dicarboxylic acids and tetraalkyl titanates. Particularly useful organotitanium compounds have organic groups attached to titanium through a titanium-oxygen-carbon linkage. The main types are ortho-esters, i.e. alcoholates and acylates in which the organic group is derived from a carboxylic acid. An organotitanium catalyst may also contain both types of the aforementioned groups attached to the same titanium atom. Operative organotitanium catalysts thus include those of the formula Ti(OR⁸)4 wherein R⁸ is alkyl, alkoxyalkyl or acyl, for example tetraisopropyl titanate, tetramethoxy-ethoxytitanate and di-isopropyl diacetoxytitanate. The preferred organotitanium catalysts for use in this invention are the chelated or partially chelated titanium compound. These materials are produced, for example by reacting an alcoholate as referred to above with an .alpha.- or .beta.-di ketone or a derivative thereof.

For the more preferred addition reaction systems for use in the present invention, suitable catalysts include Group VIII metal-based or noble metal catalysts e.g. rhodium, ruthenium, palladium, osmium, irridium or platinum containing catalysts. Platinum-based catalysts are particularly preferred and may take any of the know forms, ranging from platinum deposited onto carriers, for example powdered charcoal, to platinic chloride, salts of platinum, chloroplatinic acids and encapsulated forms thereof. A preferred form of platinum catalyst is chloroplatinic acid, platinum acetylacetonate, complexes of platinous halides with unsaturated compounds such as ethylene, propylene, organovinylsiloxanes, and styrene, hexamethyldiplatinum, PtCl₂, PtCl₃, PtCl₄, and Pt (CN)₃. The preferred platinum catalyst is a form of chloroplatinic acid, either as the commonly available hexa-hydrate form or in its anhydrous form, as taught in U.S. Pat. No. 2,823,218.

Another particularly useful catalyst is the composition that is obtained when chloroplatinic acid is reacted with an aliphatically unsaturated organosilicon compound such as divinyltetramethyl-disiloxane, as disclosed in U.S. Pat. No. 3,419,593.

Proportions of from 0.1 to 0.5 parts by weight of such complex as catalyst per 100 parts by weight of component (A), having aliphatically unsaturated substituents, are preferred. It is preferred that the platinum-based catalyst (C) is employed in an amount giving from 2 to 100 ppm by weight of platinum metal based on the total weight of the composition, more preferably 5 to 50 ppm.

The platinum group metal catalyst (C) used at least in the embodiment where the component (A) has at least two alkenyl groups according to the present invention accelerates the addition reaction between the alkenyl in component (A) and the silicon-bonded hydrogen in component (B). This component can be exemplified by platinum compounds, rhodium compounds, and palladium compounds. Platinum compounds are preferred for component (C), and component (C) can be specifically exemplified by chloroplatinic acid, alcohol-modified chloroplatinic acid, chloroplatinic acid-olefin complexes, and diketonate complexes of platinum. The particular platinum complex catalyst can be used directly by itself, or can be used in solution form as afforded by dilution with solvent, or can be used in solid form as afforded by support on the surface of a solid, or can be used in particulate form as afforded by dissolution or dispersion in thermoplastic resin. This component should be used in a catalytic quantity, which will vary with the particular species selected. In the case of use of a platinum compound as component (C), the platinum compound is in general preferably used in an amount that provides from 0.1 to 1,000 ppm, and preferably 1 to 50 ppm platinum atoms referred to the weight of component (A). Where the fabric is coated and cured on a continuous coating line, the catalyst level must be selected to allow for dry cure of the rubber with the line speed and temperature of the coating process.

Further examples of catalysts which can be incorporated into the coating compositions of the present invention are (i) metal acetylacetonates, (ii) diamides, (iii) imidazoles, (iv) amines and ammonium salts, (v) organic sulfonic acids and their amine salts, (vi) alkali metal salts of carboxylic acids, (vii) alkali metal hydroxides and (viii) fluoride salts.

Thus, example of such catalysts include for group (i) such compounds as aluminum, zinc, iron cobalt acetylacetonates; group (ii) dicyandiamide; for group (iii) such compounds as 2-methylimidazole, 2-ethyl-4-methylimidazole and 1-cyanoethyl-2-propylimidazole; for group (iv), such compounds as benzyldimethylamine, and 1,2-diaminocyclohexane; for group (v), such compounds as trifluoromethanesulfonic acid; for group (vi), such compounds as sodium acetate, for group (vii), such compounds as sodium hydroxide, and potassium hydroxide; and for group (viii), tetra n-butyl ammonium fluoride, and the like.

A filler (D) may also be present in the curable compositions for use in the coating of aerogel materials according to this invention. The fillers may be for example calcium carbonate, aluminium trihydrate, quartz, metal oxides, carbon black and diatomaceous earth. Preferably however, the filler is of substantially laminar form. This means that the preferred filler is a material where the dimensions of the particles are such that the average length and width of the particles is significantly larger than their average thickness. This will give the particles a laminar or plate-like shape. The width or length of the particles is preferably at least ten times greater than the thickness of the particles, more preferably 100 times or more. Suitable particles of the laminar fillers have an average diameter of from 1 to 500 μm, and a thickness of 1 to 100 Angstrom per layer. The actual particles very often consist of a number of layers agglomerated together, which may result in the particles having a seemingly greater thickness. However, these particles should still have a thickness that is sufficiently smaller than the width and length to result in a laminar particle. Several particles can be agglomerated by physical forces into smaller or larger clusters. The dimensional conditions outlined above, however, apply not to these larger agglomerates, but to the particles themselves. Examples of suitable fillers are philosilicates, metal flakes, expanded graphite, laminar quartz, zeolites, clays, micas and laminar graphite. It is particularly preferred that the laminar filler is selected from laminar or layer silicates, especially from pyrophillite, talc, micas, vermiculites and smectites.

Although it is preferred in an embodiment that the laminar filler is hydrophobic in nature, as this improves its compatibility with silicon-based materials, it is not required that the filler is wholly hydrophobic. Indeed some fillers, e.g. talc, are known to have some hydrophobic and some hydrophilic sites. The laminar filler may be treated to make it hydrophobic, where required, for example by the methods described below for reinforcing fillers.

In a preferred embodiment, the filler is a laminar “soft” filler, especially of a Mohs value of no more than 5, preferably no more than 2, most preferably from 0.2 to 1. Accordingly the most preferred filler is talc or aluminite, carnotite, graphite, pyrophyllite or thermonatrite.

Component (D) may be a reinforcing filler, which is preferably hydrophobic. Examples of suitable fillers include silica, titanium dioxide, ground quartz, calcium carbonate, alumino silicates, organosilicon resins. Preferred are silica fillers, most preferably fumed or precipitated silica fillers, as they have good reinforcing properties. The average particle size of these fillers may be such that the diameter ranges from 0.1 to 20 μ.m, preferably from 0.2 to 5 μm, most preferably 0.4 to 25 μ.m.

The surface of the filler particles is preferably rendered hydrophobic in order to make the filer more compatible with the compositions use din the present invention. Rendering the filler particles hydrophobic may be done either prior to or after dispersing the filler particles in component (A). This can be effected by pre-treatment of the filler particles with fatty acids, reactive silanes or reactive siloxanes. Examples of suitable hydrophobing agents include stearic acid, dimethyldichlorosilane, divinyltetramethyl disilazane, trimethylchlorosilane, hexamethyldisilazane, hydroxyl end-blocked or methyl end-blocked polydimethylsiloxanes, siloxane resins or mixtures of two or more of these. Other hydrophobing agents known in the art for such purposes may also be used, but the above exemplified materials are the most effective. Fillers which have already been treated with such compounds are commercially available from a number of sources. Alternatively, the surface of the filler may be rendered hydrophobic in situ, that is, after the filler has been dispersed in the polyorganosiloxane polymer material. This may be effected by adding to the polysiloxane component prior to , during or after the dispersion of the filler, an appropriate amount of a hydrophobing agent of the kind described above as reactive silanes or siloxanes, and heating the mixture sufficiently to cause reactions, e.g. to a temperature of at least 40.° C. The quantity of hydrophobing agent to be employed will depend for example on the nature of the agent and of the filler, and the amount of hydrophobicity required. Sufficient hydrophobic agent should be employed to endow the filler with at least a discernible degree of hydrophobicity.

Silicone resins may also be used as component (D), for example an MQ resin, that is, a resin consisting of monovalent siloxane units M and quadrivalent siloxane units Q and is preferably a resin consisting essentially of M units R²R¹₂SiO_{1/2} and R¹₃SiO_{1/2} and Q units SiO_{4/2} in which R¹ and R² are as defined above. Preferably R² is a vinyl group, with no more than 10% by weight of vinyl groups per molecule and more preferably 1 to 5% by weight of vinyl groups per molecule. The resin may be in solid or liquid form although it is preferred that the ratio of M to Q units to be such that the resin is a solid at ambient temperature and pressure.

The amount of component (D) used may be limited by the viscosity of the resulting curable liquid silicone rubber. It is desirable to keep the viscosity less than about 100,000 mPa·s at 25° C. to allow for coating of the curable liquid silicon rubber on textile. The amount of component (D) is typically from about 2 to 35 weight percent, based on the total formulation, and preferably from 5 to 20 weight percent.

The curable coating composition may contain from 0 to 1000%, preferably 0 to 500%, more preferably 0 to 200%, most preferably 10 to 150%, of the filler (D) based on the organopolysiloxane (A). It is particularly preferred that the amount of filler (D) is adapted to the degree of polymerisation (DP) of organopolysiloxane (A). Where the DP of (A) is higher than 50, it is preferred that filler (D) is present, and the higher the DP of (A) the more the amount of filler (D) becomes beneficial, provided that the viscosity of the composition as a whole remains low enough for application as a coating. The viscosity of the coating composition is preferably below 10 Pa·s. at 25° C., measured using a Brookfield viscometer with spindle 5 (or using a HAT with spindle 4) at a speed 50 rpm. Preferably this dynamic viscosity is from 0.8 to 3.5 Pa·s. Preferred compositions according to the invention typically remain at workable viscosities for at least 9 hours when stored at temperatures up to 40° C.

The curable silicon-based coating composition does not contain anymore than 3% by weight of a strongly reinforcing filler. Examples of such fillers include silica, titania, ground quartz, alumino silicates, and organosilicon resins.

The average particle size of reinforcing fillers may be from 0.1 to 20 microns diameter, preferably from 0.2 to 5 .microns, most preferably 0.4 to 2.5 .microns. The surface area of such reinforcing fillers is usually no less than 50 m²/g as measured by BET measurement. Fillers may also have equiaxed dentritic structures

Preferred curable silicon base compositions according to the invention comprise sufficient of cross-linking organosilicon material (B) to give a molar ratio of Si-bonded reactive groups in (B) to silicon-bonded groups R in (A) of from 1/2 to 10/1, more preferably from 1.1/1 to 6/1, and sufficient of catalyst (C) to ensure the reaction between the silicon-bonded groups R of compound (A) and the silicon-bonded reactive group of compound (B) can proceed. For the preferred curable compositions based on organosilicon compounds which cure by reaction of alkenyl groups present in component (A) and silicon-bonded hydrogen atoms in component (B), it is particularly preferred that the ratio of silicon-bonded hydrogen atoms to alkenyl groups is from 2/1 to 5/1, most preferably from 2.5/1 to 4.5/1. Such ratios lead to good adhesion of the curable composition to the substrate.

The curable silicone based coating composition for use in a method according to the invention, as is described below, may be provided in one part although it is preferred to package the composition in two or more parts, most preferably two parts, which are mixed prior to use. The cross-linking organosilicon compound, e.g. the organohydrogensiloxane, and the catalyst compound (C), e.g. the noble metal catalyst, are preferably stored separately. For example, at least some of organopolysiloxane compound (A), catalyst (C) and optionally all or part of the fillers (D) and (E) can be stored as one pack and the cross-linking organosilicon material, together with the remainder of Components (A), (D) and (E), can be stored as a second pack. The two parts combine the reactants in a way that permits mixing the two parts in a suitable weight ratio, e.g. 1/1 or 10/1 or 1/10. Another acceptable approach is to have part of component (A) with all of Components (B), (D) and (E) in a first part and the remainder of (A) with catalyst (C) in a second part.

The curable silicon-based composition may contain additional ingredients such as dyes, adhesion promoters, infrared opacifiers, infrared reflectors, colorants, pigments, anti-blocking agents, tribological modifiers, bath-life extenders and flexibilizers, cure inhibitors, flame retardants, antioxidants and catalyst boosters. The preferred compositions, based on a curing mechanism via addition reaction, preferably contain an addition catalyst inhibitor, for example an acetylenic alcohol, a dialkyl maleate, and/or a primary alcohol in a proportion sufficient to ensure that the coating composition cures in not less than 10 seconds at 100° C. Examples of adhesion promoting additives are epoxy-substituted alkoxysilanes described, for example, in U.S. Pat. No. 3,455,877 and alkenyl functional silanol terminated organopolysiloxanes described in U.S. Pat. No. 4,082,726, typically present at 0.1% to 3% by weight of the total weight of the curable coating composition. Other suitable additives are those that e.g. enhance the efficiency of an adhesion-promoting additive, e.g. a metal chelate compound such as acetyl acetonates e.g. triacetyl-acetonates of aluminium, tetra acetylacetonates of zirconium and triacetylacetonates of iron. Aluminium chelates are preferred, especially aluminium acetyl-acetonate. Typical amounts of chelates used are 0.01 to 5 parts by weight, preferably about 0.1 to 0.3 parts by weight per 100 parts of the composition.

The composition of the present invention can be prepared simply by the preparation of an essentially homogeneous mixture using a mixer such as, for example, a kneader mixer, kneader mixer equipped with a ram cover, an inline mixer, a static mixer, or a Ross mixer. Various techniques known in the art, such as first massing the reinforcing filler and any hydrophobing agents with a small fraction of the polyorganosiloxane before adding the rest of the components may be useful. In order to prevent premature gelling or crosslinking of the present composition, it may be useful to split the components into three parts, with one part containing the polyorganohydrogensiloxane crosslinking component (B), one part containing the curing catalyst (C), and a third part containing the oxygen curing component (E) as described above.

This invention includes a method of coating an aerogel material with an elastomer-forming composition, characterized in that a curable coating composition as defined above is applied to the elastomer-coated fabric at a coat weight from about 1 to about 200 g/m², preferably from about 10 to about 100g/m², most preferably from about 15 g/m² to about 75 g/m².

The composition may be applied on to the aerogel material according to known techniques. These include spraying, gravure coating, bar coating, dip coating, slot-die coating, coating by knife-over-roller, coating by knife-over-air, padding, curtain coating and screen-printing. It is preferred that the composition is applied by gravure coating or bar coating. Preferably the coating is applied at a level that will result after curing in a coat weight of no more than 50 g/m², preferably 5 to 10 or 15 g/m², more preferably from 2 to 6 g/m². If the curable coating of the invention is applied to give a coat weight over 15 g/m², the coating should be flexible at the level applied.

In an alternate preferred embodiment, the coating is applied by a spray process. Spraying methods are known in the art and are also described in U.S. Pat. Nos. 5,180,104, 5,102,484, 5,683,037, 5,478,014, 5,687,906, 6,488,773, 6,440,218. They are incorporated by reference to comprehensively teach application of coatings of the present invention to aerogel materials.

The aerogel material coated with the embodiments of the present invention may optionally comprise fibers, fibrous mat, fibrous batting or lofty batting. Such fibrous materials may be embedded into the aerogel material to make an aerogel composite preferably in a laminar/planar or blanket form. Fibers may reinforce the aerogel material in the resultant composite. The fibrous material used in the embodiments of the present invention may have polyester, carbon, polyacrylonitrile, oxidized polyacrylonitrile, silica, quartz, fiberglass, polyamide, polyethylene, polypropylene, cotton, polyimide, polytetrafluoroethylene(PTFE), polybenzimidazole, polyphenylenebenzo-bisoxasole, polyetherether ketone, polyacrylate, polyaramides, poly-metaphenylene diamine, poly-paraphenylene terephthalamide, ultra high molecular weight polyethylene, novoloid resins, polyacrylonitrile(Pan), oxidized PAN, or carbon. They may be made of above said materials or their combinations or alternatively comprise at least an amount of such material in fibrous form.

In an embodiment, the aerogel in the composite is in the form of a continuous matrix or unitary material or a “monolithic” material as opposed to particles or beads, i.e. to a naked eye, This is distinguished from another embodiment where aerogels are in a particulate form and are brought together in a shape by application of pressure, a binder or by an enclosure with or without fibrous materials.

The aerogel material may be already coated with an elastomer-forming composition, which may or may not be readily cured prior to application of the curable coating compositions of this invention. It is preferred that such elastomer-forming composition is a silicon-based elastomer, although organic based elastomers such as polyurethane, polyacrylates or polyvinyl chloride, are usable alternatives. It is also preferred that the elastomer forming composition has already been cured, thus forming an elastomeric coating onto the aerogel material prior to the application of the curable coating compositions of this invention.

Curing conditions for curable silicon-based coating compositions according to the invention will depend on the exact nature of the composition used, but are preferably 120 to 200° C. for a period of up to 5 minutes.

The coated aerogel materials of this invention may be used to make any articles. They are particularly suited for use in the manufacture of insulation articles. They are also used to make structural elements along with additional components as appropriate.

In another embodiment, coating composition is formulated in an aqueous medium. Polyorganosiloxane component (A) is formulated as silicon-in-water emulsions optionally with a surfactant. Microparticulate silica (F) may function to improve the post-cure strength of the coating. Collaidal silica may be an ideal component suitable for use as component (F). This component can be used in the form of the emulsion afforded by emulsification in water using surfactant, but may also be used by first mixing it into the organopolysiloxane (A) and then dispersing the resulting mixture in water using surfactant. While the quantity of component (F) addition is not critical, component (F) is preferably added at from 0.5 to 100 weight parts per 100 weight parts (A) and more preferably at from 1 to 50 weight parts per 100 weight parts (A).

The curing catalyst (C) functions to induce crosslinking of the composition according to the present invention. This component in addition to its previous description can be further exemplified for this embodiment by the metal salts of organic acids, such as dibutyltin dilaurate, dibutyltin dioctate, dioctyltin dilaurate, dioctyltin diacetate, tin octanoate, zinc stearate, zinc octanoate, and iron octanoate; and by amine compounds such as n-hexylamine and guanidine. Except in those cases in which this component is water soluble, this curing catalyst is advantageously employed in the form of the emulsion prepared in advance by emulsification in water with the aid of surfactant. While the quantity of component (C) addition is not critical, this component is preferably added at from 0.01 to 10 weight part per 100 weight parts (A) and more preferably at from 0.1 to 5 weight part per 100 weight parts (A).

An optionally component (G) which functions to improve the adherence and intimacy of contact exhibited by the composition according to the present invention, is a silatrane derivative with the following formula

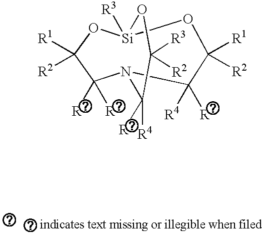

Each R¹ in this formula is independently selected from hydrogen or C₁ to C₁₀ alkyl. The alkyl encompassed by R¹ can be exemplified by methyl, ethyl, propyl, butyl, pentyl, isopropyl, isobutyl, cyclopentyl, and cyclohexyl. R¹ is preferably hydrogen or methyl. Each R² in the preceding general formula is independently selected from hydrogen, C₁ to C₁₀ alkyl, or alkoxysilyl-functional organic groups with the formula —R²Si(OR.sup.5).sub.x R⁶.sub.(3-x) in which R⁴ is a divalent organic group, R⁵ is C₁ to C₁₀ alkyl, R⁶ is a monovalent organic group, and x is 1, 2, or 3. For the purposes of the present invention, at least 1 of the R² groups is the above defined alkoxysilyl-functional organic group. The alkyl encompassed by R² can be exemplified by the same alkyl groups as for R¹. The divalent organic group R⁴ can be exemplified by alkylene groups such as methylene, ethylene, methylmethylene, propylene, methylethylene, butylene, hexylene, 1-methylpentylene, and 1,4-dimethylbutylene; and by alkyleneoxyalkylene groups such as methyleneoxypropylene and methyleneoxypentylene. R⁴ is preferably ethylene, propylene, butylene, methyleneoxypropylene, or methyleneoxypentylene. The alkyl group R⁵ can be exemplified by the same alkyl groups as for R¹ and preferably is methyl or ethyl. The monovalent organic group R⁶ can be exemplified by substituted or unsubstituted monovalent hydrocarbon groups, for which specific examples are alkyl groups such as methyl, ethyl, propyl, butyl, pentyl, isopropyl, isobutyl, cyclopentyl, and cyclohexyl; aryl groups such as phenyl, tolyl, xylyl, and naphthyl; alkenyl groups such as vinyl, allyl, butenyl, pentenyl, and hexenyl; aralkyl groups such as benzyl and phenethyl; and halogenated alkyl groups such as chloromethyl, 3-chloropropyl, 3,3,3-trifluoropropyl, and nonafluorobutylethyl. Methyl is preferred for R⁶. The following groups can be provided as examples of the alkoxysilyl-functional organic group encompassed by R².
—(CH₂)₂Si(OCH₃)₃,
—(CH₂)₂Si(OCH₃)₂CH₃,
—(CH₂)₃Si(OC₂H₅)₃,
—(CH₂)₃Si(OC₂H₅)(CH₃)₂,
—CH₂O(CH₂)₃Si(OCH₃)₃,
—CH₂O(CH₂)₃Si(OC₂H₅)₃,
—CH₂O(CH₂)₃Si(OCH₃)₂CH₃,
—CH₂O(CH₂)₃Si(OC₂H₅)₂CH₃,
—CH₂OCH₂Si(OCH₃)₃ and
—CH₂OCH₂Si(OCH₂)(CH₂)₂

R³ in the preceding formula for the silatrane derivative is selected from substituted or unsubstituted monovalent hydrocarbon groups, C.sub.1 to C.sub.10 alkoxy, glycidoxyalkyl, oxiranylalkyl, acyloxyalkyl, or aminoalkyl. The monovalent hydrocarbon groups encompassed by R³ can be exemplified by the monovalent hydrocarbon groups elaborated above for R⁶. The alkoxy encompassed by R³ can be exemplified by methoxy, ethoxy, and propoxy; the glycidoxyalkyl can be exemplified by 3-glycidoxypropyl; the oxiranylalkyl can be exemplified by 4-oxiranylbutyl and 8-oxiranyloctyl; the acyloxyalkyl can be exemplified by acetoxypropyl and 3-methacryloxypropyl; and the aminoalkyl can be exemplified by 3-aminopropyl and N-(2-aminoethyl)-3-aminopropyl. Except wherein this component is water-soluble, the subject silatrane derivative is preferably preliminarily converted into emulsion form by emulsification in water using surfactant. The quantity of component (G) addition is not critical, but this component is preferably used at from 0.01 to 10 weight parts per 100 weight parts (A) and more preferably at from 0.1 to 5 weight parts per 100 weight parts (A). The subject silatrane derivative can be synthesized, for example, by reacting an amine compound with general formula NH_{y}(CR¹₂CR¹R²OH)_{3-y} with an epoxy-functional trialkoxysilane with the general formula 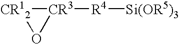
in which y=1 or 2 and R¹, R², R⁴, and R⁵ are defined as above. U.S. Pat. No. 6,180,712 exemplifies silantranes used in the present embodiments which is incorporated by reference here.

There are no particular restrictions on the surfactants used to emulsify the various components discussed hereinabove. Surfactants usable for this purpose can be exemplified by anionic surfactants such as alkyl sulfate salts, alkylbenzenesulfonate salts, and alkyl phosphate salts; nonionic surfactants such as polyoxyalkylene alkyl ethers, polyoxyethylene alkylphenyl ethers, polyoxyethylene fatty acid esters, and sorbitan fatty acid esters; cationic surfactants such as quaternary ammonium salts and the alkylamine salts of acetic acid; and amphoteric surfactants such as alkylbetaines and alkylimidazolines.

For the purposes of the present invention, it is preferred that components (A), (C), (F) and (D) constitute from 0.5 to about 70 weight percent of the water-based emulsion composition, the remainder being predominantly water. The silicon water-based emulsion composition according to the present invention may be blended with a wide variety of other components on an optional basis, such as thickeners, antifoams/defoamers, penetrants, antistatics, inorganic powders, preservatives, and silane coupling agents.

Additional ingredients such as anticorrosion agents, fungicides, oily materials like natural or modified dying oils, liquid diene compounds, unsaturated fatty acid esters may be added to the compositions of the present embodiments. These oily compounds cure to a dry surface by reacting with oxygen in the air at ambient conditions. Examples of these compounds include the natural dying oils, such as tung oil, linseed oil, vernonia oil, and oiticica oil; and modified natural drying oils such as boiled linseed oil and dehydrated castor oil; various liquid diene compounds such as 1,3-hexadiene or polybutadiene, and fatty acid esters which are unsaturated, and preferably have more than 10 carbon atoms. In the present invention, tung oil and oiticica oil are preferred because they provide the lowest tack surfaces. Most referable is tung oil, also known as China wood oil, a yellow oil obtained from Chinese seeds. Tung oil consists chiefly of the glycerides of oleic and oleomargaric acids.

In another embodiment, silicone or polyorganosiloxane is suspended in an aqueous medium. The polyorganosiloxane suspension employed by the present invention comprises the dispersion of a polyorganosiloxane microparticulate in water. While the particle size of the polyorganosiloxane microparticulate in said polyorganosiloxane suspension is not specifically restricted, the average particle size of the polyorganosiloxane microparticulate in the polyorganosiloxane suspension preferably does not exceed 200 micrometers. Particularly preferred polyorganosiloxane suspensions will contain silicon rubber microparticulate whose average particle size falls within the range of 10 nanometer to 100 micrometers: this avoids problems such as clogging, etc., when the silicon-modified water-based coating composition is applied by spraying. The quantity of addition of the polyorganosiloxane suspension is not specifically restricted as long as a sufficient quantity is added to impart a flat or mat character to the ultimately obtained coating. However, the content of the polyorganosiloxane microparticulate preferably falls within the range of 1.0 to 150 weight parts and particularly preferably within the range of 1 to 100 weight part per 100 weight parts total solids in the water-based coating composition. Viscosities of such suspensions are typically in the range of 1 to 100 Pa-s and preferably between 40 -70 Pa-s. It is important to point out that any of the components A through G described in the present application may be present in water based suspensions. Several embodiments in this application are combinable resulting in various combinations or embodiments.

Polyorganosiloxane suspension may be prepared, for example, by emulsifying a liquid polyorganosiloxane composition in water and then curing the liquid polyorganosiloxane composition. This liquid polyorganosiloxane composition is exemplified by addition-reaction-curing liquid polyorganosiloxane compositions which cure by a platinum-catalyzed addition reaction, condensation-reaction-curing liquid polyorganosiloxane compositions which cure by a condensation reaction in the presence of an organotin compound or organotitanium compound, and organoperoxide-curing liquid polyorganosiloxane compositions. However, the method for preparing the polyorganosiloxane suspension employed by the present invention is not restricted to the preceding.

Silicone rubber may be formed in particulate form which may be suspended in an aqueous medium along with cross linker and optional catalyst and optional fillers as mentioned elsewhere in this document and optionally cured subsequently. In another embodiment, fully cured silicone rubber particulates may be suspended in aqueous medium along with other optional ingredients as above.

The aforesaid addition-reaction-curing liquid silicon rubber compositions comprise liquid silicone rubber compositions whose essential components are organopolysiloxane containing silicon-bonded alkenyl groups, SiH-containing organopolysiloxane, and platinum-type catalyst. These may optionally contain filler, pigment, and curing-reaction retarder. The aforesaid condensation-reaction-curing liquid silicone rubber compositions comprise liquid silicone rubber compositions whose essential components are silanol-containing organopolysiloxane, SiH-containing organopolysiloxane or alkoxysilane, and curing catalyst (organotin compound, organotitanium compound, or platinum-type compound). The aforesaid organoperoxide-curing liquid silicone rubber compositions comprise liquid silicon rubber compositions whose essential components are vinyl-containing organopolysiloxane and organoperoxide. Both of these systems may also optionally contain filler and pigment.

Filler which may be blended into the silicone rubber compositions is exemplified by reinforcing filler such as precipitated silica, fumed silica, calcined silica, fumed titanium oxide, and the like, and by nonreinforcing filler such as powdered quartz, diatomaceous earth, asbestos, aluminosilicic acid, iron oxide, zinc oxide, calcium carbonate, and the like. This filler may be directly blended into the liquid silicone rubber composition, or it may be admixed after treatment of its surface with an organosilicon compound such as hexamethyldisilazane, trimethylchlorosilane, dimethylsiloxane oligomer, and the like. Furthermore, the following may be admixed on an optional basis: pigments, curing-reaction retarders, epoxy-containing organic compounds, amino-containing organic compounds, heat stabilizers, flame retardants, plasticizers, and noncurable organopolysiloxanes.

The silicone rubber suspension can be prepared by first (i) introducing a liquid silicon rubber composition as described above into water and forming an emulsion thereof by mixing to homogeneity using a mixing means such as a colloid mill or homomixer, and then (ii) curing the liquid silicone rubber composition. The use of a surfactant is preferred here in order to improve the storage stability of the silicone rubber suspension and in order to support an increased content of silicone rubber microparticulate. Specifically, the use of a particular type of surfactant is preferred for the purpose of preparing a silicone rubber suspension having a high concentration of silicon rubber microparticulate. For example, it is preferred to use two types of nonionic surfactants having different HLB values, and it is particularly preferred within this context that their HLB values differ by at least 5. Finally, the degree of curing of the silicone rubber is not specifically restricted.

The method for preparing the silicone-modified water-based coating composition is not specifically restricted, and it may be prepared simply by the addition, with mixing, of a separately prepared silicone rubber suspension to a water-based coating composition. The silicon-modified water-based coating composition according to the present invention may also be manufactured by preparing the coating resin component itself in the silicone rubber suspension. In the case of the preparation of a water-based coating composition whose water-based coating composition has a high total solids concentration, the use is preferred of a silicone rubber suspension having a high concentration of silicone rubber microparticulates. Also preferred for this case is the preparation of the coating resin component in the silicone rubber suspension.

With regard to components other than the silicone rubber suspension, the silicone-modified water-based coating composition according to the present invention may contain inorganic powder, thickener, pigment, and the like, as long as the object of the present invention is not impaired.

The silicone-modified water-based coating compositions according to the present invention can be applied by those coating methods employed for ordinary aqueous or organic solvent-based coating compositions, for example, spray coating, electrostatic coating, immersion coating, curtain flow coating, roll coating, shower coating, and the like. The polyoganosiloxane layer in several coatings may have a tear strength of more than 30 kN/m and preferably between 35 and 60 kN/m. The thickness of the coating may vary depending on the substrate aerogel material, reinforcement type and end applications. Typically, the thickness may be in the range of 1 to 100 mils.

Polyorganosiloxane compositions of different embodiments may be elastomeric or capable of forming an elastomer. The coated layers may exhibit an elongation-at-break (defined as elongation recorded at the moment of rupture expressed as a percentage of the original length) of at least 400% and preferably between 600 and 1000%. Optionally, fungicides or biocides may be added to any of the above compositions along with corrosion inhibitors.

### EXAMPLES

The following non-limiting examples are provided to better illustrate the embodiments of the present invention.

### Example 1

An aerogel material in a flexible blanket form made with a polyester batting and silica gel (SPACELOFT™ 3103 from Aspen Aerogels, Inc.) is coated by a knife over roller technique with a 50/50 elastomer-forming mixture of (A) through (D) to a coat weight of 50-60 g/m², followed by heat curing the blanket for 2 minutes at 150-170° C. After allowing the coating to cool down, a second coating is applied on the other side of the blanket and heat cured as above. The blanket is unrolled in a continuous form, coated as above, cured in an oven where said coated roll is passed through at said temperatures and further can be cooled and rolled up.

### Example 2

An aerogel material same as in example 1 further comprising carbon black (SPACELOFT™ 5103 from Aspen Aerogels, Inc.) is coated similar to a method described in example 1.

### Example 3

An aerogel material in a blanket form made with a silica fiber batting and silica gel (PYGOGEL® 3203 from Aspen Aerogels, Inc.) is coated with a composition prepared by mixing 59 parts of a vinyl end-blocked polydimethyl siloxane (A), sufficient of an organosilicon cross-linker having silicon-bonded hydrogen atoms, to give a number ratio of silicon-bonded hydrogen atoms to vinyl groups in the composition of 3:1, 40 parts of talc, 0.1 parts of a inhibitor and 0.7 parts of a platinum based catalyst. The vinyl end-blocked polydimethyl siloxane (A) was 9 siloxane units long and had 7.7% vinyl per molecule using a gravure coating technique to a coat weight of about 15 g/m2. The coat may be cured at 150° C. for about 3 minutes.

### Example 4

Ten parts of dodecylbenzenesulfonic acid is dissolved in 484.6 parts of water. A separately prepared mixture of 500 parts octamethylcyclotetrasiloxane and 5.4 parts of phenyltriethoxysilane is then added to the surfactant solution with stirring. The resulting mixture is passed twice through an homogenizer emulsifier at 400 kg/cm² to give an emulsion. The resulting emulsion is heated for 2 hours at 80° C., held overnight at 25.° C. and is thereafter neutralized with 10% aqueous sodium carbonate solution to give an emulsion X.

Thirty parts of dioctyltin dilaurate and 5 parts polyoxyethylene nonylphenyl ether (C₉Hl₉C₆H₅—O—(C₂H₄O)₁₀H) are mixed to uniformity using a homomixer followed by the gradual addition of 65 parts water with emulsification and dispersion in the water. The resulting mixture is passed twice through an homogenizer emulsifier at 300 kg/cm² to yield an emulsion Y.

A 500 ml flash is charged with 12.2 g of 2-hydroxyethylamine, 81.7 g of methyltrimethoxysilane, 94.5 g of 3-glycidoxypropyltrimethoxysilane, and 32.0 g of methanol and the mixture is heated with stirring for 8 hours at the methanol reflux temperature. The low boilers are then distilled off to yield a silatrane.

Twenty parts of a colloidal silica is added with stirring to 70 parts of the emulsion X. This is followed by the addition of 1 part of the emulsion Y and then by the addition of 0.5 part of the silatrane to afford a silicone water-based emulsion composition. Using an applicator, this silicone water-based emulsion composition is coated on an aerogel blanket made with a carbonized felt and silica gel so as to provide a post-drying film thickness of 3 microns. The coated aerogel is dried at room temperature overnight to yield a rubber coating.

### Example 5

The following materials are used in formulating the example that follows:

Polymer 1-Dimethylvinylsiloxy-terminated Dimethyl Siloxane, with 0.11 to 0.23 wt % vinyl, and a viscosity of 7000 to 12000 mPa·s

Polymer 2-Dimethylvinylsiloxy-terminated Dimethyl Siloxane, with 0.18 to 0.34 wt % vinyl, and a viscosity of 1800 to 2400 mPa·s.

Crosslinker Trimethylsiloxy-terminated Dimethyl, Methylhydrogen Siloxane, SIH as H, 1.00 to 1.12 wt %, with a viscosity of 25 to 40 mPa·s

Catalyst 1 percent 1,3-Diethenyl-1,1,3,3-Tetramethyldisiloxane Complex of Platinum in Dimethylvinylsiloxy-terminated Dimethyl Siloxane,

Inhibitor 1-ethynyl-1-cyclohexanol

Reinforcing filler-Cabosil ™ . . . MS-75, Cabot Corp. Tuscola, Ill. A reinforcing amorphous silica which has a surface area of 240-270 square meters per gram (M.sup.2/g).

Nonreinforcing Filler 1 Micral 855, Huber Chemical, Atlanta Ga., An alumina hydrate having an average particle size of 1.5-2.5 microns

Nonreinforcing Filler 2 Mica (W32S-SM-ML), methacryl/Organosilane Modified Mica from Franklin Industrial Minerals, Franklin, N.C.

Nonreinforcing Filler 3 Celite .RTM.Superflos, Celite (UK) Limited, North Humberside UK, Flux calcined diatomaceous earth which may contain up to 63% crystalline silica in the form of cristobalite and quartz.

Hydrophobing agent 1 Hexamethyldisilazane

Hydrophobing agent 2Hydroxy-terminated Dimethyl Siloxane, with viscosity of 38 to 45 mPa·s at 25° C., and total hydroxyl as OH 2.6 to 3.6%

Hydrophobing agent 3 mixture containing alpha-Hydroxy-, omega-Methoxy-terminated Dimethyl, Methylvinyl Siloxane, and Hydroxy-terminated Dimethyl, Methylvinyl Siloxane

Tung oil, Sea-Land Chemical Co., Westlake Ohio

Linseed oil

Adhesion promoter 1 Glycidoxypropyltrimethoxysilane

Adhesion promoter 2 Tetraisopropoxy Titanate, du Pont Speciality Chemicals, Wilmington Del.

Sample Preparation—Part A

For each sample a masterbatch is first prepared by massing the filler, the filler treating agents and about two thirds of polymers 1 and 2 in a sigma blade mixer for about two hours at about 160° C., under vacuum of at least 67 kPa. The remainder of the polymers is then added and the mixture cooled to below 80° C. before the catalyst and adhesion promoter are added.

Sample Preparation—Part B

The materials are mixed at room temperature in a closed container on a roller until homogeneous.

Sample Preparation—Part C

The part C in the formulations was 100 percent of oily components that cure to a dry surface by reacting with oxygen in the air at ambient conditions

Procedure for Coating Aerogel Material

100 gm of part A and 20 gm of part B are placed into an appropriate mixing container. When the oily component is used, it is added to the mixer at the amount specified in the example. The mixture of part A and part B, with Part C is mixed until essentially homogeneous, usually 2-3 minutes. The mixture is then coated on an aerogel material made with silica fiber batting and silica gel further opacified with ziconia using a Werner Mathis lab coater. The material is coated to approximately 30 g/m² in coating weight. The coated material was then cured in a 150° C. oven for 3 minutes. The coated aerogel blanket was allowed to stabilize for 24 hours minimum prior to testing the adhesion of the silicone to the aerogel blanket.

### Example 6

The following are mixed to prepare composition (A): 95 weight parts hydroxyl-terminated dimethylpolysiloxane with viscosity of 80 centipoise and hydroxyl content of 1.3 weight %, 5 weight parts 3-glycidoxypropyltrimethoxysilane, and 20 weight parts dimethylhydrogensiloxy-terminated methylhydrogenpolysiloxane with viscosity of 10 centistokes and silicon-bonded hydrogen content of 1.5 weight %.

The following are then mixed to give composition (B): 95 weight parts hydroxyl-terminated dimethylpolysiloxane with viscosity of 80 centipoise and hydroxyl content of 1.3 weight %, 5 weight parts 3-glycidoxypropyltrimethoxysilane, and 1.0 weight parts dibutyltin dioctoate.

These compositions (A) and (B) are introduced into separate storage tanks and the tanks were cooled to −10° C. 500 weight parts composition (A) and 500 weight parts composition (B) are supplied to a static mixer and thereby mixed to homogencity. This is then transferred to a mixer equipped with a high speed stirrer, into which 20 weight parts nonionic surfactant (Tergitol™. TMN-6, ethylene oxide adduct of trimethylnonanol) and 9.000 weight parts ion-exchanged water are poured all at once while stirring at 1,400 rpm. It is further passed through a colloid mill to afford the emulsion of a liquid silicon rubber composition. A silicone rubber suspension is prepared by holding this liquid silicone rubber composition emulsion at room temperature for 2 days. This silicone rubber suspension contains 11 weight % silicon rubber microparticles, and the average particle size of the silicone rubber microparticles is 3 micrometers. An aerogel material reinforced with polyester fiber (SPACELOFT™ 3103 from Aspen Aerogels, Inc.) is coated with the above composition using a spray coater to a coat weight of about 30 g/m².

What is claimed is:

1. A coated composite comprising:
a. A substantially planar aerogel material comprising at least one surface; and
b. at least a layer of a composition comprising a polyorganosiloxane and a cross linker on at least one surface of said aerogel material.

2. The composite of claim 1 further comprising a fibrous material.

3. The composite of claim 2 wherein fibrous material is in chopped fiber, fibrous batting, lofty fibrous batting or woven form.

4. The composite of claim 2 wherein said aerogel material is substantially continuous through said fibers.

5. The composite of claim 1 further comprising a catalyst for reaction between said polyorganosiloxane and said crosslinker.

6. The composite of claim 2 wherein the fibrous material comprises polyester, carbon, polyacrylonitrile, oxidized polyacrylonitrile, silica, quartz, fiberglass, polyamide, polyethylene, polypropylene, cotton, polyimide, polytetrafluoroethylene(PTFE), polybenzimidazole, polyphenylenebenzo-bisoxasole, polyetherether ketone, polyacrylate, polyaramids, poly-metaphenylene diamine, poly-paraphenylene terephthalamide, ultra high molecular weight polyethylene, novoloid resins, polyacrylonitrile(Pan), oxidized PAN, carbon or combinations thereof.

7. The composite of claim 1 wherein said polyoganosiloxane layer exhibiting a tear strength of 30 kN/m.

8. The composite of claim 1 wherein said polyoganosiloxane layer exhibiting a tear strength between 35 and 60 kN/m.

9. The composite of claim 1 wherein said polyoganosiloxane layer thickness is between about 1 mil and about 10 mil.

10. The composite of claim 1 wherein said polyoganosiloxane is elastomer-forming or elastomeric in nature.

11. The composite of claim 1 wherein said polyoganosiloxane layer exhibiting an elongation-at-break of at least 400%.

12. The composite of claim 1 wherein said polyoganosiloxane layer exhibiting an elongation-at-break between 600 and 1000%.

13. The composite of claim 1, wherein said polyorganosiloxane composition is made from elastomer-forming composition comprising:
(a) 100 parts by weight of a polyorganosiloxane material having on average two silicon-bonded alkenyl groups per molecule;
(b) an organosilicon compound having at least three silicon-bonded hydrogen atoms per molecule, in an amount which is sufficient to give a molar ratio of Si—H groups in (b) to alkenyl groups in (a) of from 1.1/1 to 5/1;
(c) from 1 to 25 parts by weight of a chain extender, comprising an polyorganosiloxane having two silicon-bonded hydrogen atoms;
(d) a group VIII metal based catalyst component in sufficient amounts to catalyze the addition reaction between (a) on the one hand and (b) and (c) on the other; and
(e) from 5 to 40 parts by weight of a hydrophobic filler.

14. The composite of claim 10, wherein said polyorganosiloxane composition is made from elastomer-forming composition comprising:
(a) 100 parts by weight of a polyorganosiloxane material having on average two silicon-bonded alkenyl groups per molecule, preferably one linked to each of the terminal silicon atoms of the molecule;
(b) an organosilicon compound having at least three silicon-bonded hydrogen atoms per molecule, in an amount which is sufficient to give a molar ratio of Si—H groups in (b) to alkenyl groups in (a) of from 1.1/1 to 5/1;
(c) 1 to 25 parts by weight of a polyorganosiloxane material having a silicon-bonded alkenyl groups linked to each of the terminal silicon atoms of the molecule and in addition at least one alkenyl group linked to a non-terminal silicon atom in the polyorganosiloxane chain;
(d) a group VIII metal based catalyst component in sufficient amounts to catalyse the addition reaction between (a) on the one hand and (b) and (c) on the other; and
(e) from 5 to 40 parts by weight of a hydrophobic filler.

15. The composite of claim 1 wherein the aerogel material comprises opacifiers, IR reflectors, UV reflectors, B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

16. The composite of claim 2 further comprising a binder.

17. The composite of claim 1 wherein said polyorganosiloxane composition comprises:
(A) an organopolysiloxane polymer having a siloxane backbone of degree of polymerization no more than 150 end-blocked with at least two silicon-bonded groups R, wherein R denotes an olefinically unsaturated hydrocarbon substituent, an alkoxy group or a hydroxyl group;
(B) a cross-linking organosilicon material having at least 3 silicon-bonded reactive groups;
(C) a catalyst capable of promoting the reaction between the silicon-bonded groups R of compound A and the silicon-bonded reactive group of compound B;
(D) optionally a non-reinforcing filler; and
(E) optionally up to a maximum of 3% by weight of a reinforcing filler; wherein organopolysiloxane (A) is a polymer containing vinylmethylsiloxane units in which 10 to 50 mole % of the siloxane units are vinylmethylsiloxane units or a polysiloxane containing both silicon-bonded vinyl group and silicon-bonded hydroxyl group.

18. The composite of claim 17 wherein Compound B has the general formulae (VIII) or (IX): 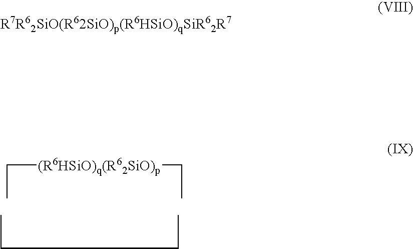
wherein R⁶ denotes an alkyl or aryl group having up to 10 carbon atoms, R⁷ is a group R⁶ or a hydrogen atom, p has a value of from 0 to 20, q has a value of from 1 to 70, and there are at least 3 silicon-bonded hydrogen atoms present per molecule.

19. The composite of claim 17 or 18 wherein the coat weight is from about 1 to about 200 g/m², preferably from about 10 to about 100 g/m², most preferably from about 15 g/m² to about 75 g/m².

20. The composite of claim 17 or 18 wherein the coating s further cured.

21. The composite of claim 17 further comprising a laminar filler (D) having a Mohs value of less than 5.

22. The composite of claim 1 wherein said polyorganosiloxane composition comprises:
(A) a polyorganosiloxane having at least 2 silicon-bonded alkenyl groups per molecule,
(B) a polyorganohydrogensiloxane containing at least 2 silicon-bonded hydrogen groups,
(C) a platinum group metal catalyst capable of promoting the reaction between the silicon-bonded alkenyl of component A and the silicon-bonded reactive group of component B,
(D) a reinforcing filler,
(E) 0.1 to 5 percent by weight, based on the total weight of components A through E, of a compound selected from the group consisting of natural drying oils and modified natural drying oils, liquid diene compounds, and unsaturated fatty acid esters.

23. The composite of claim 22 wherein the polyorganosiloxane coat weight is from about 1 to about 200 g/m², preferably from about 10 to about 100 g/m², most preferably from about 15 g/m² to about 75 g/m².

24. The composite of claim 1 wherein said polyorganosiloxane composition comprises:
a. 100 parts by weight of an organopolysiloxane having at least 2-silicongroups selected from hydroxyl or alkoxy groups in each molecule;
b. 0.5 to 100 parts by weight of a microparticulate silica;
c. 0.01 to 10 parts by weight of a curing catalyst; and
d. 0.01 to 10 parts by weight of a silatrane derivative.
